(19) United States
(12) Patent Application Publication
(10) Pub. No.: US 2009/0279054 A1
(43) Pub. Date: Nov. 12, 2009

(54) Projector and maintenance system for ballast thereof

(75) Inventors: Chih-Heng Fan Chiang, Hsinchu (TW); Hsin-Chi Chen, Hsinchu (TW)

Correspondence Address: BACON & THOMAS, PLLC, 625 SLATERS LANE, FOURTH FLOOR, ALEXANDRIA, VA, 22314-1176, US

(73) Assignee: Coretronic Corporation, Hsin-Chu (TW)

(21) Appl. No.: 12/385,635

(22) Filed: Apr. 15, 2009

(30) Foreign Application Priority Data
May 12, 2008 (TW) 09711488

(51) Int. Cl. G03B 21/20

(52) U.S. Cl. 353/85

(57) ABSTRACT

A maintenance system for a ballast is applied to a projector. The projector includes a housing. The maintenance system for the ballast includes an input/output interface and a ballast. The input/output interface is disposed on the housing, and has a first transmitting terminal, a first receiving terminal and an input/output connection port. The first transmitting terminal and the first receiving terminal are electrically connected to the input/output connection port. The input/output connection port is uncovered by the housing. The ballast is disposed inside the housing, and has a second transmitting terminal and a second receiving terminal. The second transmitting terminal is electrically connected to the first receiving terminal of the input/output interface, and the second receiving terminal is electrically connected to the first transmitting terminal of the input/output interface.

### BACKGROUND OF THE INVENTION

(1) Field of the Invention

The invention relates to a maintenance system and particularly to a maintenance system for a ballast of a projector.

(2) Description of the Related Art

A projector usually use a bulb to provide light for a image projected on the screen. To adjust the brightness of the image, a ballast is used to control the bulb.

Referring to FIG. 1, a conventional digital lighting process(DLP) projector 100 includes a housing 110. There are a bulb 120, a ballast 130, a color wheel 140, a digital micromirror device(DMD) 160, a illumination system 170, and a mainboard 180 in the housing 110. A scaler 182 and a flash memory 184 are disposed on the mainboard 180.

The light emitted by the bulb 120 is separated into multiple color lights through the color wheel 140. These color lights are transferred to the DMD 160 after several reflections or refractions of the illumination system 170. Controlled by the scaler 182, the DMD 160 modulates the color lights to produce image lights. The image lights are projected to a screen (not shown) outside the DLP projector 100 to form a colorful image through a projection lens(not shown).

The bulb 120 is electrically connected to the ballast 130. The control interface of the ballast 130 is electrically connected to the scaler 182. The scaler 182 is electrically connected to the flash memory 184. The ballast 130 has a firmware program to control the brightness of the bulb 120 by executing the firmware program.

After a period of time, the firmware program may need updating, resetting or upgrading. Thus, the conventional projector 100 uses the flash memory 184 of the mainboard 180 to store the update, reset, or upgrade information of the firmware program. When the firmware program needs resetting, the scaler 182 gets the update, reset, or upgrade information of the firmware program from the flash memory 184 and transfers the information to the ballast 130 to execute the update, reset, or upgrade information of the firmware program.

Because the ballast 130 is electrically connected to the scaler 182 inside the projector 100, when the ballast 130 fails, the error message may not reach outside of the projector 100 directly. Furthermore, when the firmware program needs updating, resetting, or upgrading, executing the update, the reset, or the upgrade information of the firmware program directly from the outside of the projector 100 may not be capable.

According to the conventional technology, if repairing and debugging the ballast 130 or updating the firmware program, the project 100 may be taken apart or even disassembled, so the conventional technology may be inconvenient and also raise labor cost.

### SUMMARY OF THE INVENTION

The invention is to provide a maintenance system for repairing a ballast of a projector more conveniently.

Other objects and advantages of the invention may be further understood from the technical features disclosed in the invention.

For achieving one, some or all of the above mentioned object, an embodiment of the invention is a maintenance system for a ballast applied to a projector. The projector has a housing. The maintenance system includes an input/output interface and a ballast. The input/output interface is disposed on the housing, and has a first transmitting terminal, a first receiving terminal, and an input/output connection port. The first transmitting terminal and the first receiving terminal are electrically connected to the input/output connection port, and the input/output connection port is uncovered by the housing. The ballast is disposed inside the housing, and has a second transmitting terminal and a second receiving terminal. The second transmitting terminal is electrically connected to the first receiving terminal of the input/output interface, and the second receiving terminal is electrically connected to the first transmitting terminal of the input/output interface.

The maintenance system mentioned above further includes a scaler having a third transmitting terminal and a third receiving terminal. The third transmitting terminal is electrically connected to the second receiving terminal of the ballast, and the third receiving terminal is electrically connected to the second transmitting terminal of the ballast.

In another embodiment, the ballast further has a forth transmitting terminal and a forth receiving terminal. The third transmitting terminal of the scaler is electrically connected to the forth receiving terminal of the ballast, and the third receiving terminal of the scaler is electrically connected to the forth transmitting terminal of the ballast.

An embodiment of the invention is a projector including a housing, a lighting element, a color wheel, and a digital micromirror device. The lighting element emits light along a light path to the outside of the housing. The color wheel and the digital micromirror device are located inside the housing and in the light path. The scaler is electrically connect to the digital micromirror device. The ballast is electrically connected to the lighting element and the scaler.

In the projector or the maintenance system mentioned above, the scaler and the input/output interface may be electrically connected to the ballast in parallel, or electrically connected to the ballast separately and independently in electrical signals transmitting. Besides, a switch, such as a multiplexer, is electrically connected to the ballast, the scaler, and the input/output interface. The input/output interface may be a video graphics array (VGA) interface or a RS232 interface.

To sum up, the input/output interface is disposed directly on the housing of the projector in the embodiment of the invention. The input/output connection port of the input/output interface is uncovered by the projector. Thus, when repairing the ballast, such as debugging, resetting, upgrading, or updating the firmware program, there may be no need to disassemble the projector. The production line may also save the step of updating the firmware program in advance when producing the projectors, and the production efficiency may be improved.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a block diagram of the conventional projector and the maintenance system for ballast thereof.

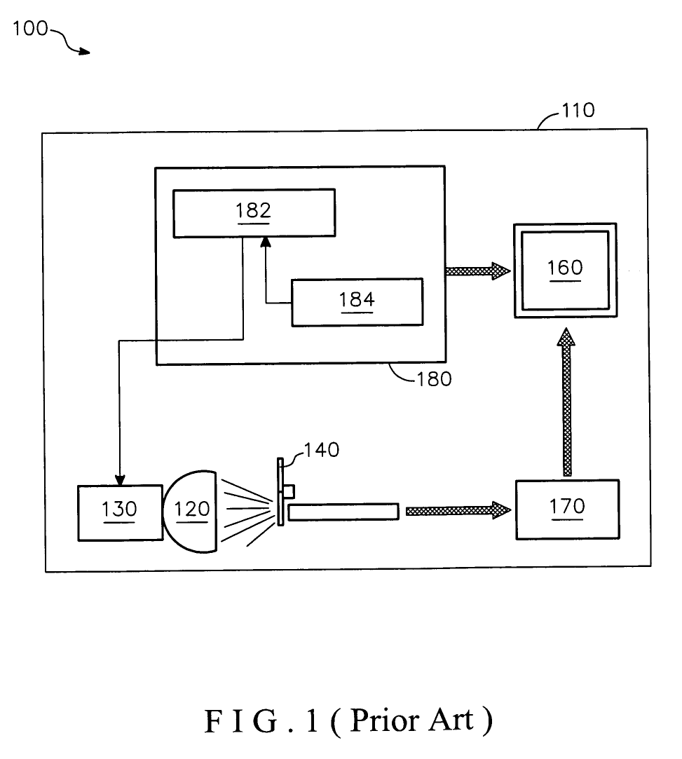

FIG. 2 is a block diagram of the first embodiment of the projector and the maintenance system for ballast thereof according to the present invention.

FIG. 3 is a block diagram of the second embodiment of the projector and the maintenance system for ballast thereof according to the present invention.

FIG. 4 is a block diagram of the third embodiment of the projector and the maintenance system for ballast thereof according to the present invention.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

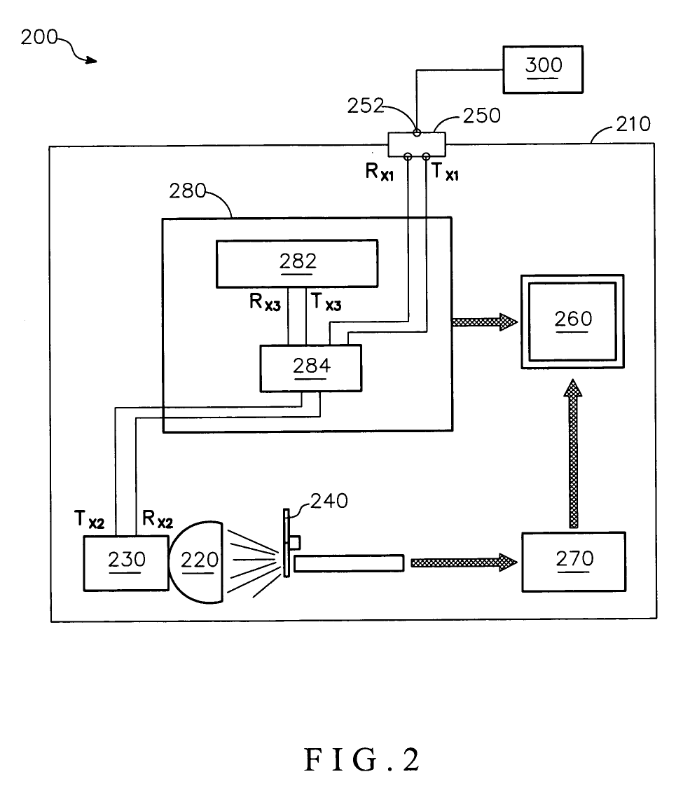

Referring to FIG. 2, a projector 200 includes a housing 210. An input/output interface 250 is disposed on the housing 210. A lighting element 220, a ballast 230, a color wheel 240, a digital micromirror device(DMD) 260, a illumination system 270, and a mainboard 280 are disposed inside the housing 210. The lighting element 220, the illumination system 270, and the DMD 260 are disposed in the same light path. The lighting element 220 is electrically connected to the ballast 230. The illumination system 270 is made up of field lenses or relay lenses. The mainboard 280 includes a scaler 282. The mainboard 280 is electrically connected to the DMD 260. The scaler 282 and the input/output interface 250 are both electrically connected to the ballast 230.

The lighting element 220 provides a light which is separated into multiple color lights by the color wheel 240. Each of the color lights is transferred to the DMD 260 after passing the illumination system 270. The DMD 260 is controlled by the scaler 282 and reflects the color lights to form a colorful image.

The ballast 230 including a firmware program has a transmitting terminal Tₓ₂ and a receiving terminal Rₓ₂. The scaler 282 has a transmitting terminal Tₓ₃ and a receiving terminal Rₓ₃. In the embodiment, the transmitting terminal Tₓ₃ and the receiving terminal Rₓ₃ of the scaler 282 are electrically connected to a switch 284, such as a multiplexer or a mechanical switch. The switch 284 is electrically connected to the transmitting terminal Tₓ₂ and the receiving terminal Rₓ₂ of the ballast 230. Thus, the scaler 282 is capable of controlling the ballast 230 through electrical signals to make the ballast 230 executing the firmware program so as to control the light intensity and period of the lighting element 220.

Noticeably, the input/output interface 250 provided in the embodiment, such as a video graphics array (VGA) interface or a RS232 interface, is disposed on the housing 210. The input/output interface 250 has a transmitting terminal Tₓ₁, a receiving terminal Rₓ₁ and an input/output connection port 252. The input/output connection port 252 is uncovered by the housing 210. The transmitting terminal Tₓ₁ and the receiving terminal Rₓ₁ are disposed inside the housing 210, and electrically connected to the input/output connection port 252. The transmitting terminal Tₓ₁ and the receiving terminal Rₓ₁ of the input/output interface 250 are also electrically connected to the switch 284, and electrically connected to the ballast 230 through the switch 284. Thus, users may use the input/output connection port 252 of the input/output interface 250 to externally connect a computer 300 having a upgrade firmware program of the ballast 230. The computer 300 outside the projector 200 may upgrade the firmware of the ballast 230 without disassembling the housing 210 of the projector 200.

In FIG. 2, when using the projector 200 to project the image, the switch 284 allows electrical signals transmitting between the scaler 282 and the ballast 230, but may not allow electrical signals transmitting between the input/output interface 250 and the ballast 230. However, when upgrading the firmware program of the ballast 230, the switch 284 allows the electrical signals transmitting between the input/output interface 250 and the ballast 230, but may not allow the electrical signals transmitting between scaler 282 and the ballast 230.

The input/output interface 250 may be used not only to upgrade the firmware program of the ballast 230, but also debug, update, or reset the firmware program of the ballast 230 by the computer 300 connected externally to the input/output connection port 252 if the computer 300 has stored the debug, update, or reset information of the firmware program. When the ballast 230 fails, the error message may be transferred to the computer 300 through the input/output interface 250. Accordingly, if repairing the ballast 230 from the outside of the projector 200, for example, debugging, updating, or resetting the firmware program of the ballast 230, at least the input/output interface 250 needs to be connected to the ballast 230 electrically. For convenience, the circuit containing the ballast 230 and the input/output interface 250 is called ‘maintenance system for ballast’ thereinafter.

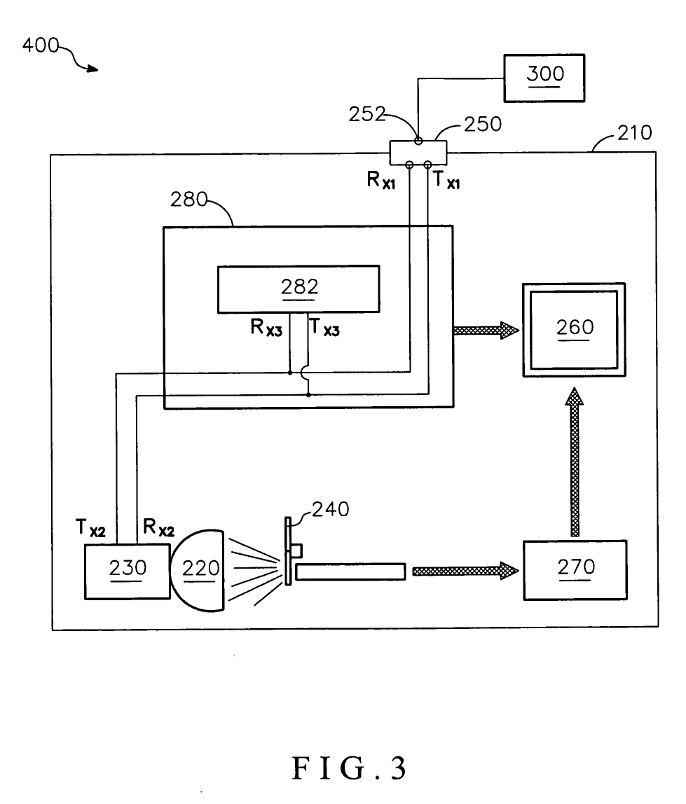

Referring to FIG. 3, in the projector 400, the maintenance system for the ballast 230 may not need the switch 284 shown in FIG. 2, and the scaler 282 and the input/output interface 250 are connected to the ballast 230 in parallel. The receiving terminal Rₓ₁ of the input/output interface 250 is electrically connected to the transmitting terminal Tₓ₂ of the ballast 230, and the receiving terminal Rₓ₃ of the scaler 282 is also electrically connected to the transmitting terminal Tₓ₂ of the ballast 230. The transmitting terminal Tₓ₁ of the input/output interface 250 is electrically connected to the receiving terminal Rₓ₂ of the ballast 230, and the transmitting terminal Tₓ₃ of the scaler 282 is also electrically connected to the receiving terminal Rₓ₂ of the ballast 230.

Because the switch 284 is not provided in the embodiment in FIG. 3 when using the projector 400, the circuit between the ballast 230 and the input/output interface 250 and the circuit between the ballast 230 and the scaler 282 may not be conducted selectively. Thus, to avoid the electrical signals from the scaler 282 to the ballast 230 interrupting the electrical signals from the input/output interface 250 to the ballast 230, the scaler 282 in the projector 400 may be unable to send any signals to the ballast 230 before upgrading, debugging, updating, or resetting the firmware of the ballast 230 or receiving the error message from the ballast 230 through the input/output interface 250.

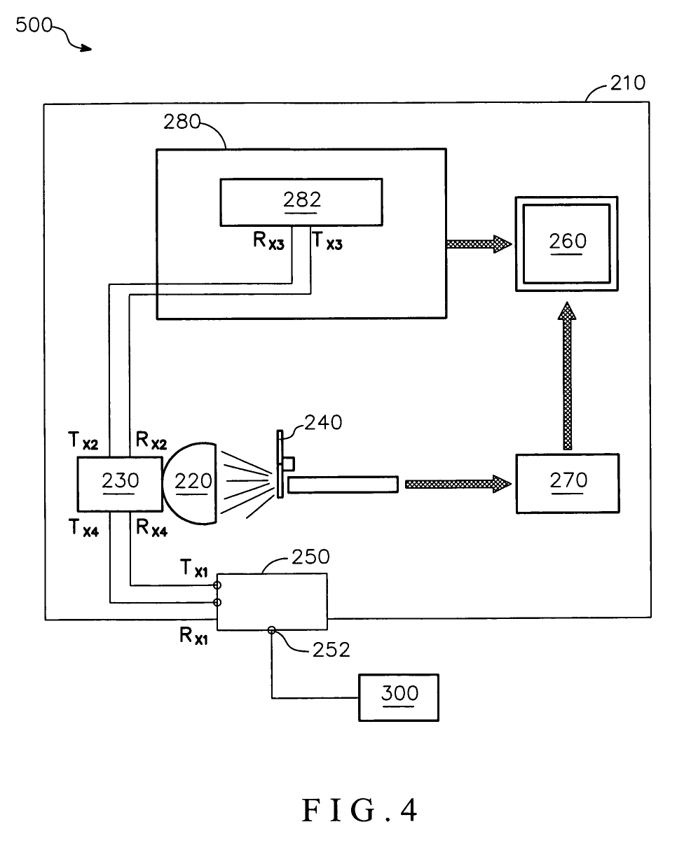

Referring to FIG. 4, in the maintenance system for the ballast 230 in the projector 500, the scaler 282 and the input/output interface 250 are electrically connected to the ballast 230, and the scaler 282 and the input/output interface 250 are separate and independent in electrical signals transmitting. The ballast 230 provides two transmitting terminals Tₓ₂, Tₓ₄ and receiving terminals Rₓ₂, Rₓ₄. The transmitting terminal Tₓ₂ is electrically connected to the receiving terminal Rₓ₃ of the scaler 282, and the receiving terminal Rₓ₂ is electrically connected to the transmitting terminal Tₓ₃ of the scaler 282. The transmitting terminal Tₓ₄ is electrically connected to the receiving terminal Rₓ₁ of the input/output interface 250, and the receiving terminal Rₓ₄ is electrically connected to the transmitting terminal Tₓ₁ of the input/output interface 250. Thus, the electrical signal transmitting path between the scaler 282 and the ballast 230 is irrelevant with the electrical signal transmitting path between the input/output interface 250 and the ballast 230.

Based on above embodiments, when upgrading, updating, or resetting the firmware program of the ballast 230, there may be no need to disassemble the projectors 200, 400, 500. When the ballast 230 fails, the error message of the ballast 230 may be obtained through the input/output interface 250 for repairing immediately. When the ballast 230 needs to update the firmware program, the projectors 200, 400, 500 need not be disassembled, and labor costs may be saved.

In conclusion, because the input/output interface 250 is disposed directly on the housing 210 of the projectors 200, 400, 500 and the input/output connection port 252 of the input/output interface 250 is uncovered by the projectors 200, 400, 500, when repairing the ballast 230, or debugging, upgrading, updating or resetting the firmware program, there may be no need to disassemble the projectors 200,400,500. The production line may also leave out the step of updating the firmware program in advance when producing the projectors 200,400,500, and the efficiency is raised.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A maintenance system for ballast applied to a projector having a housing, comprising:
an input/output interface, disposed on the housing, having a first transmitting terminal, a first receiving terminal, and an input/output connection port, wherein the first transmitting terminal and the first receiving terminal are electrically connected to the input/output connection port, and the input/output connection port is uncovered by the housing; and
a ballast, disposed inside the housing, having a second transmitting terminal and a second receiving terminal, wherein the second transmitting terminal is electrically connected to the first receiving terminal of the input/output interface, and the second receiving terminal is electrically connected to the first transmitting terminal of the input/output interface.

2. The maintenance system for ballast of claim 1, further comprising a scaler having a third transmitting terminal and a third receiving terminal, wherein the third transmitting terminal is electrically connected to the second receiving terminal of the ballast, and the third receiving terminal is electrically connected to the second transmitting terminal of the ballast.

3. The maintenance system for ballast of claim 2, further comprising a switch electrically connected to the first transmitting terminal, the first receiving terminal, the second transmitting terminal, the second receiving terminal, the third transmitting terminal, and the third receiving terminal.

4. The maintenance system for ballast of claim 3, wherein the switch is a multiplexer.

5. The maintenance system for ballast of claim 1, wherein the input/output interface is a video graphics array (VGA) interface.

6. The maintenance system for ballast of claim 1, wherein the input/output interface is a RS232 interface.

7. The maintenance system for ballast of claim 1, further comprising a scaler having a third transmitting terminal and a third receiving terminal, wherein the ballast further has a forth transmitting terminal and a forth receiving terminal, the third transmitting terminal of the scaler is electrically connected to the forth receiving terminal of the ballast, and the third receiving terminal of the scaler is electrically connected to the forth transmitting terminal of the ballast.

8. A projector, comprising:
a housing;
a lighting element, disposed inside the housing, emitting light along a light path to the outside of the housing;
a color wheel located in the light path;
a digital micromirror device located in the light path;
a scaler electrically connected to the digital micromirror device;
a ballast electrically connected to the lighting element and the scaler; and
an input/output interface disposed on the housing, electrically connected to the ballast, and having an input/output connection port uncovered by the housing.

9. The projector of claim 8, wherein the scaler and the input/output interface are electrically connected to the ballast in parallel.

10. The projector of claim 8, further comprising a switch electrically connected to the ballast, the scaler, and the input/output interface.

11. The projector of claim 10, wherein the switch is a multiplexer.

12. The projector of claim 8, wherein the input/output interface is a video graphics array (VGA) interface.

13. The projector of claim 8, wherein the input/output interface is a RS232 interface.

14. The projector of claim 8, wherein the scaler and the input/output interface are electrically connected to the ballast, and the scaler and the input/output interface are separate and independent in electrical signals transmitting.
